(19) United States
(12) Patent Application Publication
(10) Pub. No.: US 2013/0320753 A1
(43) Pub. Date: Dec. 5, 2013

(54) COIL COMPONENT, AND ELECTRONIC DEVICE AND POWER OVER ETHERNET SYSTEM HAVING THE SAME

(71) Applicant: SAMSUNG ELECTRO-MECHANICS CO., LTD., Suwon (KR)

(72) Inventors: Chang Hyun KIM, Suwon (KR); Young Min LEE, Suwon (KR); Jong Hae KIM, Suwon (KR); Jin Woo PARK, Suwon (KR); Jae Gen EOM, Suwon (KR); Jae Sun WON, Suwon (KR)

(73) Assignee: SAMSUNG ELECTRO-MECHANICS CO., LTD., Suwon (KR)

(21) Appl. No.: 13/652,670

(22) Filed: Oct. 16, 2012

(30) Foreign Application Priority Data
May 31, 2012 (KR) 10-2012-0058730

(51) Int. Cl. H01F 27/29; H04B 3/54; H01F 38/14

(52) U.S. Cl. 307/1; 336/192; 307/104

(57) ABSTRACT

There are provided a coil component in which a plurality of coil parts are integrated in a single component, and an electronic device and a Power over Ethernet (PoE) system having the same. The coil component includes: a base having external connection terminals fastened thereto; a core coupled to the base; and a plurality of coil parts electromagnetically coupled to the core through a coil wound around the core.

### CROSS-REFERENCE TO RELATED APPLICATIONS

This application claims the priority of Korean Patent Application No. 10-2012-0058730 filed on May 31, 2012, in the Korean Intellectual Property Office, the disclosure of which is incorporated herein by reference.

### BACKGROUND OF THE INVENTION

1. Field of the Invention

The present invention relates to a coil component, and an electronic device and a Power over Ethernet (PoE) system having the same, and more particularly, to a coil component in which a plurality of coil parts are integrated into a single component, and an electronic device and a PoE system having the same.

2. Description of the Related Art

In current business and industrial environments, in order to improve communications, inter-organizational cooperation, security, and productivity, the use of network-based devices has rapidly increased. Respective network-based devices require a power supply cable as well as a data cable. In light of this requirement, requirement for the supply of power through a data circuit has arisen, such that Power over Ethernet (PoE) technology has been developed.

In PoE technology, data and power are simultaneously transmitted using an Ethernet, a typical wired local area network (LAN) scheme, wherein an Ethernet is a type of wired LAN technology having a bus structure in which a carrier sense multiple access with collision detection (CSMA/CD) scheme is used in order to transmit data. PoE technology was established as the IEEE 802.3af standard on June, 2003, and a PoE system has been defined as network-based devices receiving data and power from power sourcing equipment (PSE) devices through a CAT-5 Ethernet cable (a UTP cable).

A powered device (PD) receiving power by PoE technology is powered by PSE devices through the UTP cable. Here, the powered device may generally be an internet protocol (IP) phone, a wireless LAN access point (AP), a webcam, or the like.

In the PoE system according to the related art, respective PSE devices and powered devices (PDs) are provided with a plurality of coil components. More specifically, respective PSE devices and powered devices (PD) may be provided with a pulse transformer for data transmission and reception and may additionally be provided with a common mode filter.

However, in the case of the related art, since the plurality of coil components should be mounted in both the PSE device and the powered device (PD), a volume of the device itself, device manufacturing costs thereof, and time required to manufacture the device may be increased.

### RELATED ART DOCUMENT

(Patent Document 1) Korean Patent Laid-open Publication No. 2007-0102559

### SUMMARY OF THE INVENTION

An aspect of the present invention provides a coil component capable of performing various functions.

Another aspect of the present invention provides a coil component capable of reducing a volume, manufacturing costs, and a manufacturing time of an electronic component and a Power over Ethernet (PoE) system.

According to an aspect of the present invention, there is provided a coil component including: a base having external connection terminals fastened thereto; a core coupled to the base; and a plurality of coil parts electromagnetically coupled to the core through a coil wound around the core.

The plurality of coil parts may include at least one pulse transformer.

The plurality of coil parts may include at least one common mode filter.

At least two of the plurality of coil parts may have independent magnetic paths formed in the core.

The core may include an outside part having a ‘□’ shape, and a partition wall having a ‘T’ shape within the outside part.

The plurality of coil parts may be formed by winding the coil around the outside part of the core.

The plurality of coil parts may include a first coil part formed on either side of the outside part of the core, and a second coil part formed on a side of the outside part facing the first coil part.

The first and second coil parts may have respective magnetic paths formed independently by the partition wall.

The plurality of coil parts may include third and fourth coil parts formed on a side of the outside part of the core.

The third and fourth parts may share a magnetic path completed by the partition wall.

The base may include at least one coupling protrusion firmly coupling the base to the core while penetrating through the core.

The base may include a seating groove formed in one surface thereof in which the core is seated, the seating groove having the core partially inserted thereinto.

The core may be formed of at least two different materials, corresponding to a plurality of magnetic paths formed by the plurality of coil parts.

According to another aspect of the present invention, there is provided an electronic device including: a transceiver having a transmission port and a reception port for transmitting and receiving data signals; and a coil component relaying the data signals to the transceiver, wherein the coil component includes both of a first coil part connected to the transmission port of the transceiver and a second coil part connected to the reception port of the transceiver.

The first and second coil parts may be pulse transformers simultaneously transmiting DC power and the data signals.

The coil component may further include a common mode filter filtering the data signals.

The coil component may include both of the pulse transformers and the common mode filter formed in a single core.

According to another aspect of the present invention, there is provided a Power over Ethernet (PoE) system including: a powered device; and a power sourcing equipment (PSE) device transceiving data signals while simultaneously transmitting power to the powered device, wherein at least one of the powered device and the power sourcing equipment (PSE) device includes a coil component having two pulse transformers formed in a single core in order to transmit and receive the data signals.

The coil component may further include a common mode filter formed in the core and filtering the data signals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block circuit diagram schematically showing a Power over Ethernet (PoE) system according to an embodiment of the present invention;

FIG. 2 is a perspective view schematically showing a coil component according to the embodiment of the present invention;

FIG. 3 is an exploded perspective view of FIG. 2;

FIG. 4 is a plan view schematically showing a state in which a coil is wound around a core of the coil component shown in FIG. 2;

FIG. 5 is a circuit diagram corresponding to FIG. 4;

FIG. 6 is a plan view illustrating a magnetic path formed in a core of FIG. 4;

FIGS. 7A and 7B are cross-sectional views of a core according to another embodiment of the present invention;

FIG. 8A is a perspective view of a coil component according to another embodiment of the present invention; and

FIG. 8B is an exploded perspective view of FIG. 8A.

### DETAILED DESCRIPTION OF THE INVENTION

Prior to a detailed description of the present invention, the terms or words, which are used in the specification and claims to be described below, should not be construed as having typical or dictionary meanings. The terms or words should be construed in conformity with the technical idea of the present invention on the basis of the principle that the inventor(s) can appropriately define terms in order to describe his or her invention in the best way. Embodiments described in the specification and structures illustrated in drawings are merely exemplary embodiments of the present invention. Thus, it is intended that the present invention covers the modifications and variations of this invention, provided they fall within the scope of their equivalents at the time of filing this application.

Exemplary embodiments of the present invention will be described in detail with reference to the accompanying drawings. The same reference numerals will be used throughout to designate the same or like elements in the accompanying drawings. Moreover, detailed descriptions related to well-known functions or configurations will be ruled out in order not to unnecessarily obscure subject matters of the present invention. In the drawings, the shapes and dimensions of some elements may be exaggerated, omitted or schematically illustrated. Also, the size of each element does not entirely reflect an actual size.

Hereinafter, embodiments of the present invention will be described in detail with reference to the accompanying drawings.

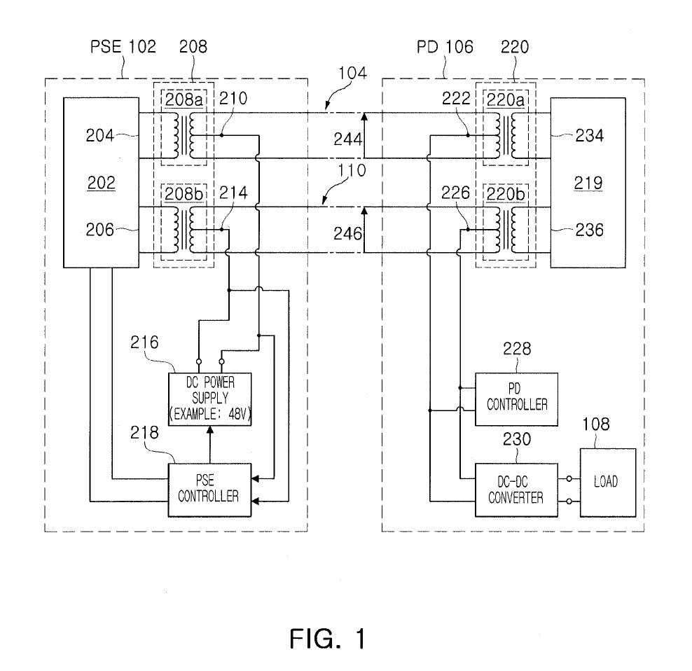

FIG. 1 is a block circuit diagram schematically showing a Power over Ethernet (PoE) system according to an embodiment of the present invention.

Referring to FIG. 1, in the PoE system, a system providing direct current (DC) power and data communications through a common data communications medium, a power sourcing equipment device (hereinafter, referred to as a PSE device) 102 provides the DC power to a powered device (hereinafter, referred to as a PD) 106 having an exemplary electrical load 108 through conductors 104 and 110.

The PSE device 102 and the PD 106 may also include data transceivers 202 and 219 operated according to the known communications standard, for example, the IEEE Ethernet standard. More specifically, the PSE device 102 and the PD 106 may respectively include the transceivers 202 and 219, physical layer devices, and transceive data signals therebetween at high speed.

Power transmission between the PSE device 102 and the PD 106 is performed by the conductors 104 and 110 simultaneously with an exchange of the data signals.

Conductor pairs 104 and 110 may carry a high speed differential data communications signal. For example, respective conductor pairs 104 and 110 may include a single pair of twisted wires or a plurality of pairs of twisted wires or include a communications medium capable of carrying a data transmission signal and a DC power transmission signal between the PSE device 102 and the PD 106.

In the case of the Ethernet communications, the conductor pairs 104 and 110 may include a plurality of pairs of twisted wires such as four pairs of twisted wires used in a 10 gigabit (Gbit) Ethernet network.

The PSE device 102 may be a power sourcing equipment device having a plurality of ports communicating with a single PD device or a plurality of PD devices.

The PSE device 102 may include the transceiver 202 that is a physical layer device having full duplex transmission and reception capabilities through a differential transmission port 204 and a differential reception port 206.

A first coil part 208a, a pulse transformer, may perform a relay so that a high speed data signal may be transceived between the transmission port 204 and a first conductor pair 104. Similarly, a second coil part 208b, a pulse transformer, may perform a relay so that a high speed data signal may be transceived between the reception port 206 and a second conductor pair 110.

Here, the first and second coil parts 208a and 208b may transmit the data signals at high speed between the transceivers 202 and 219 and at the same time, block other low frequency voltage signals or DC voltage signals from being introduced into the transmission and reception ports 204 and 206 sensitive to a large voltage value.

Respective first and second coil parts 208a and 208b may include a first winding and a second winding and at least one of the first and second coil parts 208a and 208b may include a center tap 210 or 214.

A DC power supply 216 may generate an output voltage to be supplied through the center taps 210 and 214 of the first and second coil parts 208a and 208b.

The center tap 210 of the first coil part 208a may be connected to a first output of the DC power supply 216, and the center tap 214 of the second coil part 208b may be connected to a second output of the DC power supply 216. Therefore, the first and second coil parts 208a and 208b may block DC voltage transferred from the DC power supply 216 from being introduced into the data transmission and reception ports 204 and 206 of the transceiver 202.

Here, the DC output voltage of the DC power supply 216 may be 48 V, but the present invention is not limited thereto. That is, other voltage values may be used according to voltage/power requirements of the PD 106.

Meanwhile, the first and second coil parts 208a and 208b according to the embodiment of the present invention may be formed of a single coil component, which will be described below.

In addition, the PSE device 102 may include a PSE controller 218. The PSE controller 218 may sense and verify a compatible PD 106, determine a power classification signature for the verified PD 106, supply power to the PD 106, monitor the supplied power, and reduce or remove the supply of the power to the PD 106 when the power is no longer requested or required.

The PD 106 may be a terminal, that is, an Internet phone or a wireless access point. The PD 106 may include the transceiver 219 having a differential transmission port 236 and a differential reception port 234 and a PD controller 228.

Similar to the PSE device 102, the PD 106 may also include a first coil part 220a and a second coil part 220b.

The first coil part 220a may transceive high speed data between the first conductor pair 104 and the reception port 234. In addition, the second coil part 220b may transceive high speed data between the transmission port 236 and the second conductor pair 110.

The first and second coil parts 228a and 228b may transmit the high speed data between the transceivers 202 and 219 and at the same time, block other low frequency voltage signals or DC voltage signals from being introduced into the transmission and reception ports 234 and 236.

In addition, center taps 222 and 226 of the first and second coil parts 220a and 220b may supply the DC power carried through the conductors 104 and 110 to the load 108 of the PD 106. Here, the load 108 indicates a dynamic power draw level required to drive the PD 106.

A DC to DC converter 230 may be selectively inserted in front of the load 108 to lower a voltage so as to satisfy voltage requirements of the PD 106. In addition, a plurality of DC to DC converters 230 may be disposed in parallel with each other to output a plurality of different voltages (3 volts, 5 volts, and 12 volts), thereby supplying the plurality of different voltages to different loads 108 of the PD 106.

The PD controller 228 may monitor a voltage and a current of the PD 106 side. For example, the PD controller 228 may provide required impedance characteristics to a return conductor 110. Therefore, the PSE controller 218 may recognize that the PD 106 is a valid PoE device.

In the PoE system configured as described above, the transmission of the data and the supply of the DC power may be simultaneously performed between the PSE device 102 and PD 106.

However, first and second communications signals 244 and 246 may be differential signals simultaneously transmitted through the conductor pairs 104 and 110 between the PSE device 102 and the PD 106 in a differential scheme. Therefore, even in the case that the DC power and the data signals are transmitted together through the same conductor pairs 104 and 110, the data signals may not be affected by the DC power.

Meanwhile, the PSE device 102 and the PD 106 of the PoE system according to the embodiment of the present invention may include at least two coil parts mounted in a signal coil component. A detailed description thereof will be provided below.

Hereinafter, for convenience of explanation, a coil component mounted in the PD 106 will be described. However, the coil component according to the present embodiment is not limited to being mounted in the PD 106, but may also be mounted in the PSE device 102.

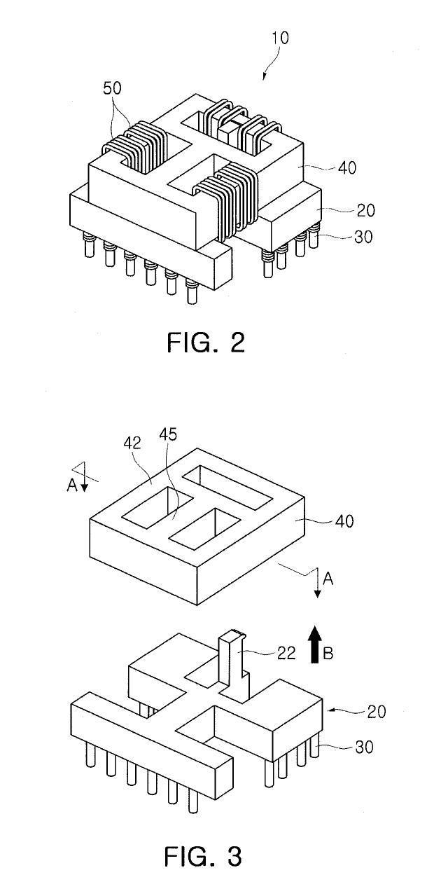

FIG. 2 is a perspective view schematically showing a coil component according to the embodiment of the present invention. In FIG. 3, an exploded perspective view of FIG. 2, the coil component is shown in a state in which a coil is omitted.

Referring to FIGS. 2 and 3, a coil component 10 according to the present embodiment may include a base 20, a core 40, and a coil 50.

The base 20 may be formed as a frame and may be coupled to the core 40 to be described below to support the core 40. Therefore, the overall shape of the base 20 may correspond to that of the core 40.

In addition, when the base 20 is coupled to the core 40, the base 20 may support portions of the core 40 around which the coil 50 is not wound. Therefore, the base 20 according to the present embodiment may have a shape corresponding to the portions of the core 40 around which the coil 50 is not wound.

Further, the base 20 according to the present embodiment may include a coupling protrusion 22 and external connection terminals 30.

The coupling protrusion 22 maybe provided in order to allow the base 20 and the core 40 to be firmly coupled to each other. To this end, the coupling protrusion 22 may be protruded from one surface of the base 20 to which the core 40 is coupled, and may have a length at which it is protruded outwardly of the core 40 while penetrating through the core 40 when the core 40 is coupled to the base 20.

In addition, the coupling protrusion 22 may have a distal end formed as a fastener to allow the base 20 and the core 40 to be firmly coupled to each other. The fastener of the distal end of the coupling protrusion 22 may support an outer surface of the core 40 when the core 40 is coupled to the base 20. Therefore, the core 40, coupled to the base 20 by the coupling protrusion 22, may not be easily separated from the base 20.

Meanwhile, although the case in which only a single coupling protrusion 22 is provided in the base 20 is described by way of example in the present embodiment, the present invention is not limited thereto. That is, a plurality of coupling protrusions may be disposed at various positions, corresponding to the shape or size of the core 40.

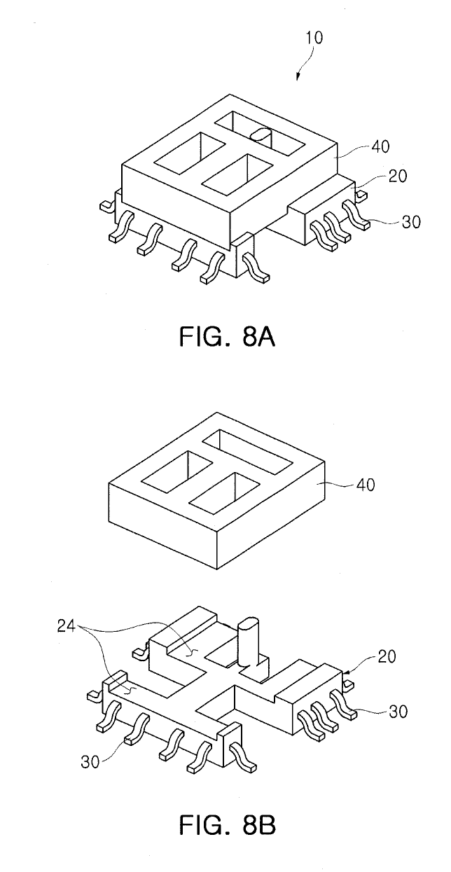

The external connection terminals 30 may be fastened to the base 20 along an edge of the base 20. A case in which the external connection terminals 30 are coupled to the base 20 in a form in which they are protruded downwardly from a lower surface of the base 20 is described by way of example in the present embodiment. However, the present invention is not limited thereto, but may be variously modified. For example, as shown in FIG. 8A, the external connection terminals 30 may be fastened to sides of the base 20.

The external connection terminals 30 maybe physically and electrically connected to a substrate (not shown) on which the coil component 10 is mounted while simultaneously being electrically connected to the coil 50 to be described below.

The base 20 may be easily manufactured by injection molding, but is not limited thereto. That is, the base 20 may also be manufactured by various methods such as a press processing method, and the like. In addition, the base 20 according to the present embodiment may be formed of an insulating resin material and a material having high heat resistance and high voltage resistance. Therefore, as a material of the base 20, polyphenylenesulfide (PPS), liquid crystal polyester (LCP), polybutyleneterephthalate (PBT), polyethyleneterephthalate (PET), phenolic resin, and the like, may be used. However, the present invention is not limited thereto.

The core 40 maybe seated on the base 20 such that they are coupled to each other. Here, the core 40 may be firmly coupled to the base 20 by the coupling protrusion 22 of the base 20, as described above.

The core 40 may be formed of an Mn—Zn-based ferrite having higher permeability, lower loss, higher saturation magnetic flux density, higher stability, and lower production costs, as compared to other materials. However, in the embodiment of the present invention, the shape or material of the core 40 is not particularly limited.

In addition, as shown in FIG. 3, the core 40 according to the present embodiment may include an outside part 42 having a ‘□’ shape and a partition wall 45 having a ‘T’ shape within the outside part 42.

This shape of the core 40 is to provide a plurality of independent magnetic paths. That is, the partition wall 45 having the ‘T’ shape is formed in the core 40, such that three independent magnetic paths φ1 to φ3 maybe formed in the core 40 according to the present embodiment.

Therefore, the coil component 10 according to the present embodiment may simultaneously perform various functions through a single core 40. That is, the coil component 10 according to the embodiment of the present invention may include at least two independent coil parts (for example, a pulse transformer and a common mode filter), which may share the above-mentioned single core 40 and independently perform their own functions.

The coil 50 may be directly wound around the core 40 to form a plurality of coil parts and have both ends connected to the external connection terminals 30 provided in the base 20.

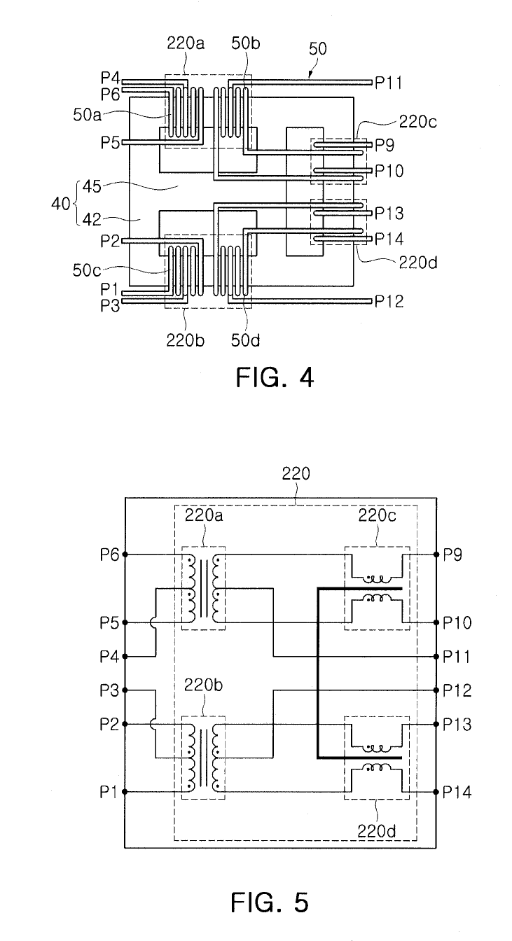

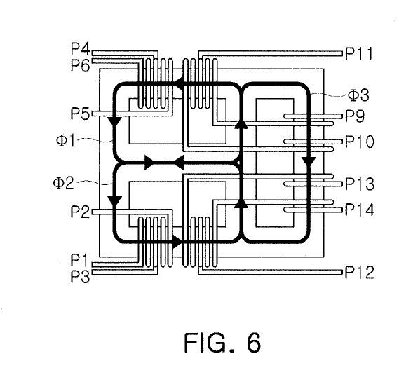

FIG. 4 is a plan view schematically showing a state in which the coil is wound around the core of the coil component shown in FIG. 2; FIG. 5 is a circuit diagram corresponding to FIG. 4; and FIG. 6 is a plan view illustrating a magnetic path formed in the core of FIG. 4. Here, FIGS. 4 and 6 show the core and the coil in direction B of FIG. 3.

Referring to FIGS. 4 through 6, the coil component according to the present embodiment may include a plurality of coil parts 220a to 220d. Here, a single coil part refers to a unit in which two coils 50a and 50b (for example, a primary coil and a secondary coil) wound around the core 40 are electromagnetically coupled thereto.

More specifically, the coil component 10 according to the present embodiment may include at least one pulse transformer 220a and 220b and at least one common mode filter 220c and 220d.

In addition, the coil 50 according to the present embodiment may include first and second coils 50a and 50b for configuring a first coil part 220a and third and fourth coils 50c and 50d for configuring a second coil part 220b. Here, reference numerals P1 to P14 used at distal ends of each coil refer to respective pins connected to the external connection terminals 30 (See FIG. 3).

The first coil part 220a and the second coil part 220b according to the present embodiment may be independently configured pulse transformers, and the first to fourth coils 50a to 50d may each have a center tap as described above.

In addition, the second coil 50b and the fourth coil 50d may configure a third coil part 220c and a fourth coil part 220d, respectively. Here, the third and fourth coil parts 220c and 220d may be common mode filters.

The third and fourth coil parts 220c and 220d forming the common mode filters may be disposed between the first and second coil parts 220a and 220b which are the pulse transformers and the conductor pairs 104 and 110 (See FIG. 1) in order to filter an electromagnetic interference (EMI) component of power introduced from the PSE device 102 to the PD 106.

In addition, the third and fourth coil parts 220c and 220d may be formed by winding portions of the coils 50b and 50c configuring the first and second coil parts 220a and 220b around the core 40. Therefore, the third and fourth coil parts 220c and 220d and the first and second coil parts 220a and 220b may be configured as a single coil component 10.

All of the first to fourth coil parts 220a to 220d may be disposed on the outside part 42 of the core 40. This may significantly reduce interference between magnetic paths formed by the first to fourth coil parts 220a to 220d.

More specifically, the first and second coil parts 220a and 220b which are the pulse transformers may be disposed on sides facing each other in the outside part 42, respectively. That is, the first coil part 220 may be disposed on either side of the outside part 42 of the core 40, and the second coil part 220 may be disposed on a side of the outside part 42 facing the first coil part 220.

Therefore, as shown in FIG. 6, respective pulse transformers may have independent magnetic paths φ1 and φ2 having significantly reduced interference therebetween.

In addition, both of the third and fourth coil parts 220c and 220d which are the common mode filters may be disposed on one side of the core 40. Therefore, the third and fourth coil parts 220c and 220d may share a magnetic path φ3 completed by the partition wall 45.

Here, a further partition wall may be added to the core so that the third and fourth coil parts 220c and 220d may also have independent magnetic paths, respectively. However, since the third and fourth coil parts 220c and 220d only have a small amount of interference therebetween while being operated, even in the case that they share a single magnetic path φ3, a sufficient effect may be obtained.

Meanwhile, in the coil component 10 according to the embodiment of the present invention, the plurality of coil parts 2201 to 220d may be independently operated through the single core 40. Therefore, the core 40 may be changed into various forms in order to optimize efficiency of the core 40.

The case in which the overall core 40 is formed of the same material is shown by way of example in FIG. 4. Here, the core 40 is formed of Ni—Zn.

However, the core 40 according to the embodiment of the present invention is not limited thereto.

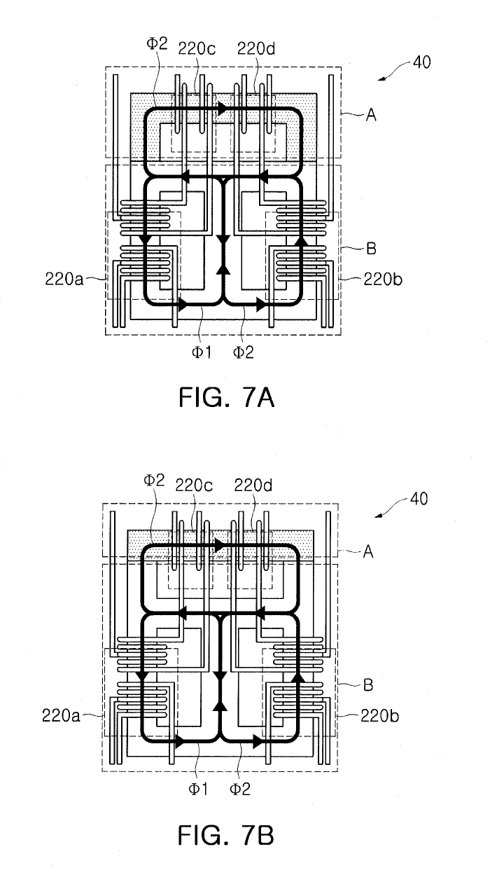

FIGS. 7A and 7B are cross-sectional views of a core according to another embodiment of the present invention. FIGS. 7A and 7B show cross-sectional views taken along line A-A of FIG. 3.

As shown in FIGS. 7A and 7B, the core 40 according to the present embodiment may be divided into region A forming the magnetic paths φ1 and φ2 of the first and second coil parts 220a and 220b and region B forming the magnetic path φ3 of the coil parts 220c and 220d. In addition, region A and region B may be formed of different materials.

For example, as a material of region A, Ni—Zn may be used. In addition, region B may be formed of a mixture of Ni—Zn and Mn—Zn.

That is, the core 40 according to the present embodiment may be formed using partially different materials in order to optimize magnetic flux density with respect to the pulse transformers 220a and 220b and the common mode filters 220c and 220d.

As described above, the coil component 10 according to the present embodiment may include at least three independent magnetic paths due to the shape of the core 40 having the partition wall 45.

Therefore, the first and second coil parts 220 which are the pulse transformers may have independent magnetic paths φ1 and φ2, respectively, and the third and fourth coil parts 220 which are the common mode filters may share a single magnetic path φ3.

Therefore, even in the case that the plurality of coil parts 220 are simultaneously operated through the core 40, the generation of interference between the respective coil parts may be significantly reduced.

In the coil component 10 according to the present embodiment configured as described above, the plurality of coil components provided independently according to the related art, that is, the pulse transformers and the common mode filters may be integrated as a single coil component.

Therefore, a size of a product, manufacturing costs, and a manufacturing time may be significantly reduced, as compared to the use of the plurality of components according to the related art.

Meanwhile, although the case in which the coil component according to the above-mentioned embodiment of the present invention is mounted in the PD 106 has been described by way of example, the present invention is not limited thereto, but may be variously modified. For example, the above-mentioned coil component maybe applied to the PSE device 102.

In addition, the coil component according to the embodiment of the present invention is not limited to the above-mentioned embodiment, but may be variously modified.

FIG. 8A is a perspective view of a coil component according to another embodiment of the present invention; and FIG. 8B is an exploded perspective view of FIG. 8A. In FIGS. 8A and 8B, the coil component is shown in a state in which a coil is omitted.

The coil component according to the present embodiment is configured similarly to that of the coil component according to the above-mentioned embodiment of the present invention, except for a structure of a base. Therefore, a detailed description of the same configuration as that of the above-mentioned embodiment of the present invention will be omitted, and the structure of the base will be described in detail.

Referring to FIGS. 8A and 8B, the coil component 10 according to the present embodiment may include a seating groove 24 formed in the base 20.

The seating groove 24 may be formed as a groove in one surface of the base 20 facing the core 40 so that the core 40 may be stably seated on and coupled to the base 20.

Therefore, the seating groove 24 may have a shape corresponding to that of the core 40, and the core 40 may be coupled to the base 20 by being partially inserted into the seating groove 24 when it is coupled to the base 20.

In addition, the coil component 10 according to the present embodiment may be fastened to the base 20 in a form in which the external connection terminals are protruded from sides of the base 20.

In the coil component 10 according to the present embodiment configured as described above, the core 40 and the base 20 may be more stably coupled to each other. In addition, since the external connection terminals 30 are disposed on the sides of the base 20 rather than a lower surface thereof, the overall thickness or mounting height of the coil component 10 may be reduced.

The coil component, and the electronic device and the PoE system having the same described above are not limited to the above-mentioned embodiments, but may be variously modified.

For example, although the case in which the overall shape of the core is rectangular has been described by way of example in the above-mentioned embodiments of the present invention, the present invention is not limited thereto. That is, the core may have various shapes such as a circular shape, an oval shape, a polygonal shape, and the like, as needed.

Further, although the coil component mounted in the PoE system has been described by way of example in the above-mentioned embodiments of the present invention, the present invention is not limited thereto, but maybe variously applied to any electronic device or system using a plurality of coil parts.

As set forth above, in a coil component and an electronic device and a PoE system having the same according to embodiments of the present invention, a plurality of coil components provided independently according to the related art, that is, pulse transformers and common mode filters may be integrated as a single coil component.

Therefore, a size of a product may be reduced and manufacturing costs and a manufacturing time may be significantly reduced, as compared to the use of a plurality of components according to the related art.

While the present invention has been shown and described in connection with the embodiments, it will be apparent to those skilled in the art that modifications and variations can be made without departing from the spirit and scope of the invention as defined by the appended claims.

What is claimed is:

1. A coil component comprising:
a base having external connection terminals fastened thereto;
a core coupled to the base; and
a plurality of coil parts electromagnetically coupled to the core through a coil wound around the core.

2. The coil component of claim 1, wherein the plurality of coil parts include at least one pulse transformer.

3. The coil component of claim 2, wherein the plurality of coil parts include at least one common mode filter.

4. The coil component of claim 1, wherein at least two of the plurality of coil parts have independent magnetic paths formed in the core.

5. The coil component of claim 1, wherein the core includes:
an outside part having a ‘□’ shape; and
a partition wall having a ‘T’ shape within the outside part.

6. The coil component of claim 5, wherein the plurality of coil parts are formed by winding the coil around the outside part of the core.

7. The coil component of claim 5, wherein the plurality of coil parts include:
a first coil part formed on either side of the outside part of the core; and
a second coil part formed on a side of the outside part facing the first coil part.

8. The coil component of claim 7, wherein the first and second coil parts have respective magnetic paths formed independently by the partition wall.

9. The coil component of claim 7, wherein the plurality of coil parts include third and fourth coil parts formed on a side of the outside part of the core.

10. The coil component of claim 9, wherein the third and fourth parts share a magnetic path completed by the partition wall.

11. The coil component of claim 1, wherein the base includes at least one coupling protrusion firmly coupling the base to the core while penetrating through the core.

12. The coil component of claim 1, wherein the base includes a seating groove formed in one surface thereof in which the core is seated, the seating groove having the core partially inserted thereinto.

13. The coil component of claim 1, wherein the core is formed of at least two different materials, corresponding to a plurality of magnetic paths formed by the plurality of coil parts.

14. An electronic device comprising:
a transceiver having a transmission port and a reception port for transmitting and receiving data signals; and
a coil component relaying the data signals to the transceiver,
wherein the coil component includes both of a first coil part connected to the transmission port of the transceiver and a second coil part connected to the reception port of the transceiver.

15. The electronic device of claim 14, wherein the first and second coil parts are pulse transformers simultaneously transmiting DC power and the data signals.

16. The electronic device of claim 15, wherein the coil component further includes a common mode filter filtering the data signals.

17. The electronic device of claim 16, wherein the coil component includes both of the pulse transformers and the common mode filter formed in a single core.

18. A Power over Ethernet (PoE) system comprising:
a powered device; and
a power sourcing equipment (PSE) device transceiving data signals while simultaneously transmitting power to the powered device,
wherein at least one of the powered device and the power sourcing equipment (PSE) device includes a coil component having two pulse transformers formed in a single core in order to transmit and receive the data signals.

19. The PoE system of claim 18, wherein the coil component further includes a common mode filter formed in the core and filtering the data signals.
